(19) United States
(12) Patent Application Publication
(10) Pub. No.: US 2006/0155986 A1
(43) Pub. Date: Jul. 13, 2006

(54) Method and system for distribution of software

(76) Inventors: Geert Kleinhuis, Eernewoude (NL); Hendrikus Johannes Joosten, Lz Roden (NL); Jan-Wiepke Knobbe, Groningen (NL)

Correspondence Address: MICHAELSON AND WALLACE;PARKWAY 109 OFFICE CENTER, 328 NEWMAN SPRINGS RD, P O BOX 8489, RED BANK, NJ, 07701, US

(21) Appl. No.: 10/534,951

(22) PCT Filed: Nov. 18, 2003
(86) PCT No.: PCT/NL03/00808

§ 371 Date: Oct. 7, 2005

(30) Foreign Application Priority Data
Nov. 18, 2002 (EP) 02079781.7

(51) Int. Cl. H04L 9/00

(52) U.S. Cl. 713/156

(57) ABSTRACT

Method for distribution of software components, which may comprise deriving a first software component identifier from a relevant software component, creating integrity test data by performing an integrity test on the software component, creating an integrity certificate comprising the integrity test data by a certificate originator, labeling the integrity certificate with the first software component identifier by the integrity certificate originator, retrieving the software component by a user's computer (3), deriving by the user's computer (3) a second software component identifier from the downloaded software component, retrieving the integrity certificate by the user's computer (3) using the second software component identifier, disclosing the integrity test data to a user by the user's computer (3).

### FIELD OF THE INVENTION

The invention relates to a method, a server, a user's computer and a software carrier comprising a computer program for distribution of software components.

### BACKGROUND

Currently, several hundred-billion dollars are lost annually caused by malfunctioning software components. While distribution of software components, e.g. via the internet, is a generally accepted practice, methods that guarantee proper execution of the software without damaging the user's system e.g. PC, are inadequate.

The following is known in this respect:

1. The relevant component provider signs its software component using a digital certificate (e.g. Microsoft's “Authenticode”). This known method has several drawbacks:

The known certificates do not relate to (the functionality on the component itself, but certify that it is produced by a manufacturer (e.g. Microsoft).

The known certificates do not provide guarantees with respect to the functionality of components, nor do they guarantee that the component implements such functionality correctly. A manufacturer that the end user does not trust may create the known certificates.

2. The component executes within ‘environment software’ that provides an execution environment for such components so as to limit and control what components can do. Examples of ‘environment software’ are: the Java Virtual Machine, the Visual Basic Runtime environment, the Flash environment. This has the following drawbacks:

It is hard (if not impossible) for an end-user to find out what functionalities an active component can and cannot use within such an execution environment. Consequently, an end-user cannot determine the risks he runs by executing components.

There is no guarantee that the execution environment in fact implements its alleged functionality, nor that it prevents any other functionality from executing.

The environment software itself can be seen as an active component. For such components there is no environment software (other than the operating system) that might guarantee that it only does what it is supposed to do.

3. Components tend to more and more Include functionality that serves the interest of the component provider, but jeopardizes the interests of the end-user (spy-ware). The component provider would have no problem signing this software, but still the user may not appreciate such functionality as it infringes his privacy.

4. The component provider has some kind of version control in place, and lets executing components check for updates on a regular basis, for the purpose of patching the software in case a security flaw would be detected. While this is useful for the component provider, this method is an ‘a posteriori’ means of achieving integrity that the user would have expected to have been there already.

5. Methods that guarantee the integrity of hardware or other tangible products already exist (e.g. the Common Criteria certification procedures). However, this is not an on-line, real-time solution for software components to be used in operational environments.

Currently developments are known for standardized testing of software and software components. Such software can be tested to quality standards relating to criteria like robustness, reliability soundness, completeness, functionality, etc. These criteria are known as “Common Criteria” (CC). The CC represents an outcome of a series of efforts to develop criteria for evaluation of IT security that are broadly useful within the international community. In the early 1980's the Trusted Computer System Evaluation Criteria (TCSEC) was developed in the United States. In the succeeding decade, various countries began initiatives to develop evaluation criteria that built upon the concepts of the TCSEC but were more flexible and adaptable to the evolving nature of IT in general. In Europe, the European Commission published the Information Technology Security Evaluation Criteria (ITSEC) version 1.2 in 1991 after joint development by the nations of France, Germany, the Netherlands, and the United Kingdom. In Canada, the Canadian Trusted Computer Product Evaluation Criteria (CTCPEC) version 3.0 was published in early 1993 as a combination of the ITSEC and TCSEC approaches. In the United States, the draft Federal Criteria for Information Technology Security (FC) version 1.0 was also published in early 1993, as a second approach to combining North American and European concepts for evaluation criteria. Work had begun in 1990 in the International Organization for Standardization (ISO) to develop a set of international standard evaluation criteria for general use. The new criteria (CC) was to be responsive to the need for mutual recognition of standardized security evaluation results in a global IT market [4].

Even though a user may check the software manufacturer's identity using a digital signature, there is no guarantee however that software downloaded by the user complies with the manufacturers specifications and quality standards.

### SUMMARY

It is an object of the invention to enable distribution of software, whereby the software can be verified according to well-defined specifications and test criteria.

This object is achieved in a method for distribution of software components which can comprise deriving a first software component identifier from a relevant software component, creating integrity test data by performing an integrity test on the software component, creating an integrity certificate comprising the integrity test data by a certificate originator, labeling the integrity certificate with the first software component identifier by the integrity certificate originator, retrieving the software component by a users computer, deriving by the users computer a second software component Identifier from the downloaded software component, retrieving the integrity certificate by the users computer using the second software component identifier, disclosing the integrity test data to a user by the user's computer. In this way a user who has acquired software can easily check if the software is conform his expectations, e.g. as version, functionality, security, etc as specified by the software manufacturer is concerned.

A user, intending to use a certain software component, may select that software component and derive its software identifier, e.g. by computing a software file's secure hash value or digest, i.e. the fixed-length result of a one-way hash function [1]. From the certificate register the integrity certificate of the selected software component may be retrieved, inspected and evaluated manually or e.g. by the users client software. The decision whether or not to execute the software component, may be based on the result of such evaluation.

Preferably, the identity of the integrity certificate originator may be verified by the user, e.g. by checking the issuer's digital signature. A digital signature guarantees that a signed file (data) has not been altered, as if it were carried in an electronically sealed envelope. The “signature” can be an encrypted digest (one-way hash function) of the file. The user extracts a first digest from the certificate that was sent and also computes a second digest from the received file. If the first and second digests match, the file is proved intact and tamper free from the sender [2]. The integrity certificate originator may be indicated as “trusted”. The user is certain that he has acquired software having the desired quality and properties and the integrity certificate comes surely from the integrity certificate originator of his choice.

Another aspect is that the user may set preferred (e.g. minimum) requirements concerning the software component's integrity. The retrieved integrity certificate then may be matched to the user's preferred requirements and preferably reported to the user. Thereby for example enabling an automatic check before installation.

Another aspect is to retrieve the requested integrity certificates from a certificate register. The certificate register may reside in the users client software, browser, e-mail client etc. As an alternative, the requested integrity certificates may be retrievable from a register (e.g database) of e.g. the certificates originator. The integrity certificate may even be received from the software supplier itself. Whatever the register's location may be, it is important that the integrity certificate always has to be issued (originated) by a reliable and unprejudiced party, i.e. trusted certificates originator. So the integrity certificate always has to be verified to be issued by one of the trusted certificates originators. To that end the user client software may comprise a register containing public key (PK) certificates of one or more certificates originators that can be trusted. Additionally, the trusted certificates originator's digital signature may be verified with a(nother) trusted third party.

The integrity certificate comprises data referring to the software component's integrity, e.g. comprising a rating of its quality with respect to items like robustness, reliability, soundness, completeness etc.. Preferably use may be made of the “Common Criteria” (CC).

Integrity data of software components may be assigned by means of integrity certificates, made according to a well-defined scale of integrity-levels. Each certificate may comprise data about e.g. the evaluation method, the scale used, etc. Users (or systems) requesting an integrity certificate for a given software component thus are enabled to verify the integrity of said software component before installation or execution.

In another aspect the object is achieved according to the invention in a server, arranged for deriving a first software component identifier from a relevant software component, creating integrity test data by performing an integrity test on the software component, creating an integrity certificate comprising the integrity test data by a certificate originator, labeling the integrity certificate with the first software component identifier by the integrity certificate originator, allowing the retrieval of the software component by a user's computer, allowing the retrieval of the integrity certificate by the user's computer using a second software component identifier.

Thus an integrity certificate originator is enabled to create integrity certificates.

In yet another aspect the object is achieved according to the invention in a user' computer, arranged for retrieving a software component by a user's computer, deriving by the user's computer a software component identifier from the downloaded software component, retrieving the integrity certificate using the software component identifier, disclosing integrity test data to a user.

Thus a user is able to acquire and check a software component for its quality and functionality.

In yet another aspect the object is achieved according to the invention in a data carrier such as a magnetic or optical disk, containing a computer program for installation on a user's computer, for arranging the user's computer to perform the steps of retrieving a software component by a user's computer, deriving by the user's computer a software component identifier from the downloaded software component, retrieving the integrity certificate using the software component identifier, disclosing integrity test data to a user.

Thus it is possible to distribute a computer program enabling the buyer to apply the method as described above.

### DRAWINGS

FIG. 1 shows schematically an architecture in which the invention may be executed.

FIG. 2 shows a prior-art screen dump (Microsoft's© Authenticode©) for input and/or modification of security settings for new software components.

### DETAILED DESCRIPTION

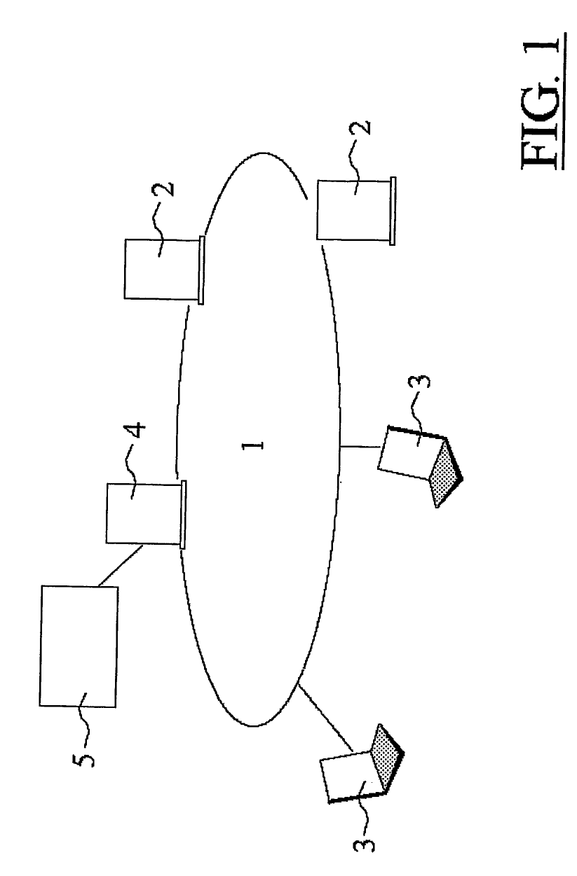

FIG. 1 shows a network 1, e.g. the Internet, to which several content servers 2 and terminals (client or user's computers) 3 are connected. Besides, a certificates server 4 is connected to the network 1. The certificates server 4 may be connected to a (trusted) certificates originator 5. Certificates made by the certificates originator 5 may be registered in a certificates register within or labeled with server 4.

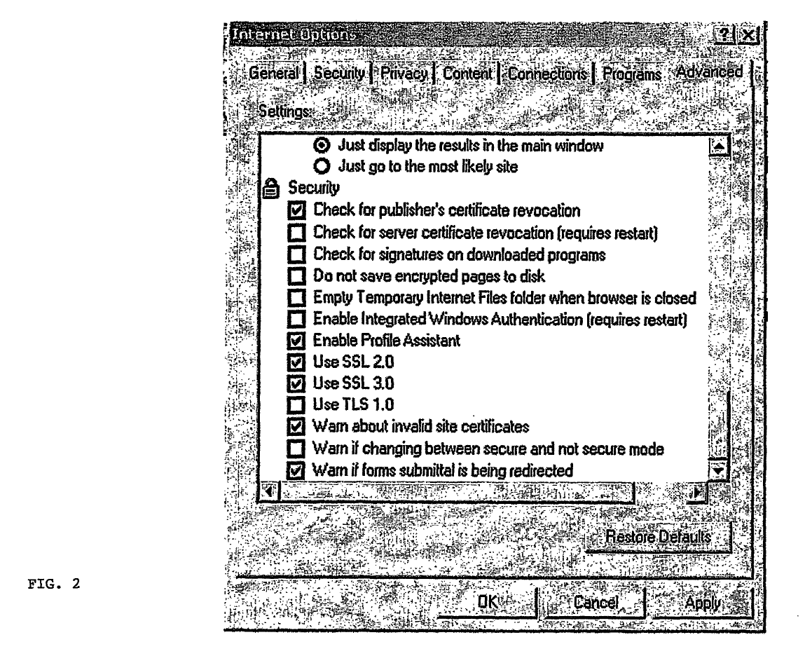

According to the state-of-the-art, the client terminals 3 have the capability to select, download and execute software components. Each terminal 3 may download selected software (or other content) from the servers 2, e.g. via the network address http://www.shareware.com. Before downloading the software, the terminal's client software may ask whether or not the software supplier can be trusted, e.g. via the user client's settings, e.g. as shown in FIG. 2.

Distribution of software components via the distribution network 1 goes as follows.

The user using computer 3, intending to use a certain software component, e.g. a program called INVENT, issued by unknown publisher, will try to download the relevant program files, e.g. comprised by a self-executing ZIP file called INVENT.EXE. The software component may also be emailed to the user's computer 3. Before installing and executing the program after having downloaded the file INVENT.EXE, the user may wish to know some more about the program's quality, integrity, reliability etc., to prevent or at least to reduce the chance that the program exhibits undesired behaviour at the user's computer 3.

According to an embodiment of the invention, a user's computer 3 is arranged to calculate a software component identifier. The user's computer 3 may therefore comprise a utility, which is able to calculate a secure hash or digest of the INVENT.EXE file, e.g. a 160-bits hash, which serves as a unique software component identifier of the downloaded INVENT.EXE file. This utility may be in the form of a plug-in the computer's Internet browser or mail client.

Subsequently, the user transmits via the network I the calculated identifier to a trusted integrity certificate originator, via the certificates server 4, requesting, by retrieving in the server's register, an integrity certificate which matches with the identifier. Network 1 may be the Internet, a company LAN or WAN or any other global computer network.

If server 4 indeed finds an integrity certificate (or more integrity certificates) labeled with the software identifier, the certificate(s) may be downloaded to the user's computer 3. The user then may be able to read and evaluate the integrity test data as comprised by the integrity certificate(s) of the selected software component, retrieved from the certificate register.

The integrity certificate may comprise a digital signature, proving the source of the certificate. Use may be made of signing the certificate by e.g. by using the Digital Signature Algorithm (FIPS 186-2. Digital Signature Standard (DSS)) thus enabling the receiving user to detect whether the certificate was issued by the trusted integrity certificate originator, viz. by checking the digital signature on the certificate.

To be able to distribute integrity certificates of several software components, server 4 has to maintain a register—e.g. a database—comprising integrity certificates—e.g. made by a software testing agency. The software testing agency is preferably an independent agency like e.g. National Software Testing Labs (NSTL) [5] or iBeta Software Quality Assurance [6] or TNO [7]. The test data may be forwarded to the integrity certificate originator.

Each integrity certificate comprising test data, reflecting the results of the testing efforts like CC tests etc., is labeled with a unique software component identifier.

In a preferred embodiment according to the invention the unique software component identifier is formed by the hash value resulting from e.g. a secure 160 bits hash function. Both the test results, registered as integrity certificate, and the hash identifier are mutually linked and can be registered in the certificate register of server 4. Optionally, the relevant software's integrity certificates and their linking identifiers may (also) be registered in other servers, e.g. in the software supplier servers 2, and/or even in the user's computer 3 e.g. the certificates of software components which optionally (not yet installed) may be used e.g. as plug-ins etc. in the user terminal's client software like browsers etc.

In each case, in whatever location or server an integrity certificate may be registered, the integrity certificate originator always has to be independent. For that reason it may be very important to verify, by the user, the identity of the integrity certificate originator, e.g. by checking the originator's digital signature.

Finally, after having received the relevant integrity certificate(s)—including a check to its origin—the contents of each certificate may be inspected and evaluated by the user personally. The integrity certificate may be downloaded or be emailed from server 4.

Optionally the user may set preferred (e.g. minimum) requirements concerning the software component's integrity. E.g. an additional client plug-in may be enabled for matching the retrieved integrity certificate to the user's preferred requirements.

It is noted that software component distributors (servers 2) may offer the service to distribute their software components in a software package including the relevant integrity certificate, e.g. including the certificate within the (see the above example) INVENT.EXE (self-executable) ZIP file.

In that case the user only needs to compute the file's hash value and to check whether the integrity certificate is linked indeed to that hash value and to check whether a trusted integrity certificate originator originates the certificate.

It is also noted that the presented method may be applied when software components are distributed via a distribution network like the internet, or via more conventional distribution means, viz. via physical distribution of CDROM's (or diskettes) comprising the relevant software. As stated above, the software certificate might be included in the software package of the CD or diskettes. In the way as depicted above, the user is enabled to calculate the software component's identifier and to verify and evaluate the certificate's content

### REFERENCES

1. http://lookup.atomica.com/atomica2/query?s=hash value (© Computer Language Company Inc)

2. http://lookup.atomica.com/atomica2/query?s=digital signature (© Computer Language Company Inc)

3. http://www.columbia.edu/acis/rad/columbiaca/more-info-cas.html

4. http://www.commoncriteria.org/docs/origins.html

5. http://www.nstl.com/

6. http://www.ibeta.com/

7. http:/www.tno.nl

1. Method for distribution of software components, comprising
deriving a first software component identifier from a relevant software component;
creating integrity test data by performing an integrity test on the software component;
creating an integrity certificate comprising the integrity test data using the first software component identifier by the integrity certificate originator;
retrieving the software component by a user's computer (3);
deriving by the user's computer (3) a second software component identifier from the downloaded software component;
retrieving the integrity certificate by the user's computer (3) using the second software component identifier;
disclosing the integrity test data to a user by the user's computer (3).

2. The method according to claim 1, further comprising registering in a certificate register (4) the integrity certificate of the relevant software component using the first software component identifier.

3. The method according to claim 2, wherein the retrieving of the integrity certificate comprises the accessing of the certificate register.

4. The method according to claim 1, further comprising verifying the identity of the integrity certificate originator.

5. The method according to claim 4, further comprising adding a digital signature to the integrity certificate.

6. The method according to claim 5, comprising verifying the digital signature.

7. The method according to claim 1, further comprising matching the retrieved integrity data to a user's preferred requirements.

8. The method according to claim 1, wherein the relevant integrity certificate is retrieved from a register at the user's side.

9. The method according to claim 1, wherein the relevant integrity certificate is retrieved from the relevant software component supplier's computer.

10. The method according to claim 1, wherein the relevant integrity certificate is retrieved from a trusted certificates originator's computer.

11. The method according to claim 1, wherein the integrity certificate is mailed through email to the user's computer (3).

12. A server (4), arranged for
deriving a first software component identifier from a relevant software component;
creating integrity test data by performing an integrity test on the software component;
creating an integrity certificate comprising the integrity test data by a certificate originator;
labeling the integrity certificate with the first software component identifier by the integrity certificate originator;
allowing the retrieval of the software component by a user's computer (3);
allowing the retrieval of the integrity certificate by the user's computer (3) using the second software component identifier.

13. A user's computer (3), arranged for
retrieving a software component by a user's computer (3);
deriving by the user's computer (3) second software component identifier from the downloaded software component;
retrieving the integrity certificate using the software component identifier;
disclosing integrity test data to a user.

14. A data carrier such as a magnetic or optical disk, comprising a computer program for installation on a user's computer (3), for arranging the user's computer (3) to perform the steps of:
retrieving a software component by a user's computer (3);
deriving by the user's computer (3) a software component identifier from the retrieved software component;
retrieving the integrity certificate using the software component identifier;
disclosing integrity test data to a user.
